(19) United States
(12) Patent Application Publication
(10) Pub. No.: US 2011/0047564 A1
(43) Pub. Date: Feb. 24, 2011

(54) OPTICAL DISK PACKAGING STRUCTURE

(75) Inventor: Chi-Hsuan SUN, Jhonghe City (TW)

Correspondence Address: Muncy, Geissler, Olds & Lowe, PLLC, 4000 Legato Road, Suite 310, FAIRFAX, VA, 22033, US

(73) Assignee: Tst Infortech Co., Ltd.

(21) Appl. No.: 12/546,396

(22) Filed: Aug. 24, 2009

(51) Int. Cl. G11B 7/24

(52) U.S. Cl. 720/719

(57) ABSTRACT

An optical disk packaging structure includes primarily a cartridge and an optical disk. The cartridge is formed by adhering correspondingly a first sheet and a bottom sheet, the first sheet is formed with a first window and a surface of the first sheet is coated with a layer of separator film. The bottom sheet, on the other hand, is defined with a peel-off part. As a peel-off range of the peel-off part is sufficient for removing out the optical disk, when a user is take outing the optical disk, entire beauty of the packaging will not be spoiled.

### BACKGROUND OF THE INVENTION

a) Field of the Invention

The present invention relates to a packaging structure and more particularly to an optical disk packaging structure, allowing an optical disk to be emplaced into a paper cartridge packaging structure and flatness of entire appearance of the packaging to be maintained.

b) Description of the Prior Art

An optical disk has already been a popular 3C (Computing, Communication and Consumer) accessory product and the optical disk is divided into a CD (Compact Disc) and a DVD (Digital Versatile Disc) by data storage capacity. In existing street stalls, there are a lot of CD boxes or packaging bags to hold the optical disks, and by these packaging devices, it is able to avoid scratching the optical disks when carrying them and to facilitate accommodating the optical disks. However, for the CD boxes that are sold on a market, a cover of the optical disk cannot be watched directly from outside and sizes of the CD boxes are large that it will be very inconvenient in accommodating or carrying the CD boxes. On the other hand, although the packaging bags are smaller and easier to accommodate that carrying them is relatively convenient, entire appearance is rather shacky that an entire sense of quality is unable to be improved.

Accordingly, how to solve the aforementioned issues and shortcomings of a prior art is a direction of improvement for research and development by the present inventor and related vendors.

### SUMMARY OF THE INVENTION

The primary object of the present invention is to provide an optical disk packaging structure which is primarily constituted by a cartridge and an optical disk, wherein the cartridge is formed by adhering correspondingly a first sheet and a bottom sheet, the first sheet is formed with a first window and a surface of the first sheet is coated with a layer of separator film. Therefore, through the first window, a type of optical disk which is put on the first window can be viewed. In addition, the bottom sheet is defined with a peel-off part and as a peel-off range of the peel-off part is sufficient for removing out the optical disk, when a user is to take out the optical disk, he or she can peel off the peel-off part and take out the optical disk. By this method, the optical disk can be effectively protected, a cover of the optical disk can be seen directly and entire beauty of the packaging will not be spoiled when taking out the optical disk.

Another object of the present invention is to provide an optical disk packaging structure that by the separator film on the first sheet, the optical disk can be also protected from being scratched and damaged by an external force.

Still another object of the present invention is to provide an optical disk packaging structure that flatness of entire appearance of the packaging and handiness can be maintained, so as to facilitate mailing to comply with a standard of automatic handling of international mails.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows a three-dimensional exploded view of a preferred embodiment of the present invention.

FIG. 3 shows a cutaway view of a preferred embodiment of the present invention.

FIG. 4 shows a schematic view of a state that a cartridge of the present invention is adhered.

FIG. 5 shows a schematic view of a state of the present invention that an optical disk is taken out.

FIG. 6 shows a three-dimensional exploded view of another preferred embodiment of the present invention.

FIG. 7 shows a cutaway view of FIG. 6 of the present invention.

FIG. 8 shows another schematic view of a state that a cartridge of the present invention is adhered.

### DETAILED DESCRIPTION OF THE PREFERRED EMBODIMENTS

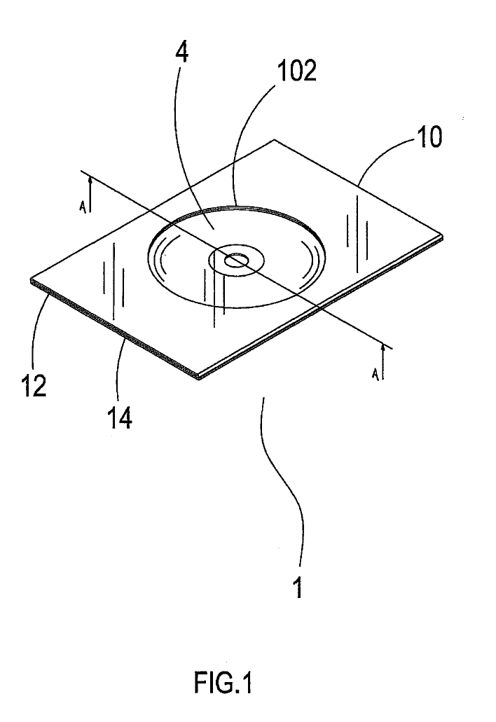

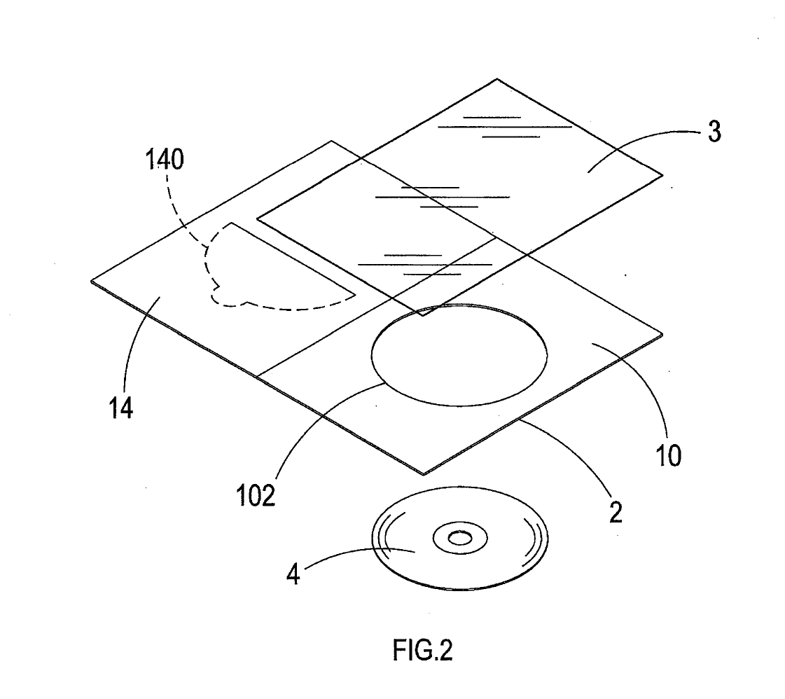

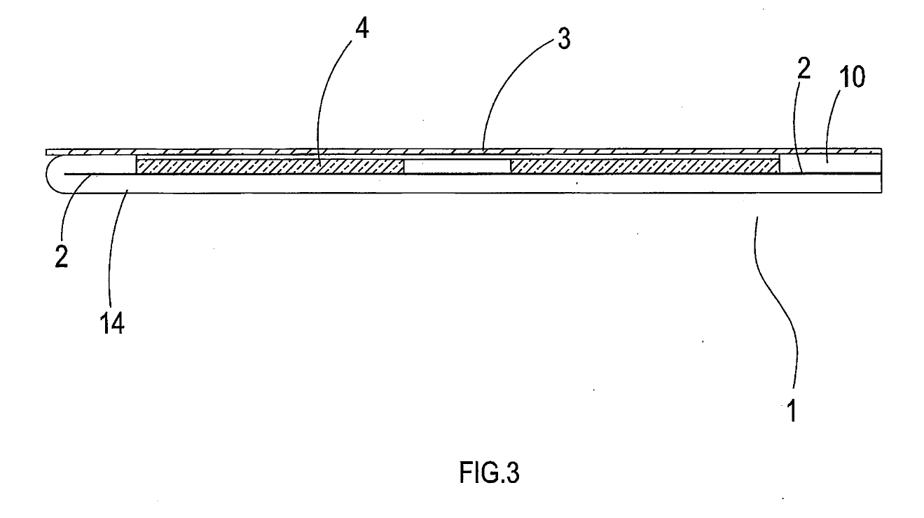

Referring to FIGS. 1 to 3, it shows a three-dimensional view, a three-dimensional exploded view and a cutaway view, of a preferred embodiment of the present invention. As shown in the drawings, the present invention is an optical disk packaging structure which comprises primarily a cartridge 1 and an optical disk 4, wherein the cartridge 1 is formed by adhering correspondingly a first sheet 10 and a bottom sheet 14 through an adhesive layer 2, the first sheet 10 is formed with a first window 102 and a surface of the first sheet 10 is coated with a layer of separator film 3 (transparent or semi-transparent). As a result, through the first windows 102, a type of the optical disk 4 which is put on the first window 102 can be seen. In addition, the bottom sheet 14 which is extended from a side of the first sheet 10 is defined with a peel-off part 140 at a pre-determined position. As a peel-off range of the peel-off part 140 is sufficient for removing out the optical disk 4, when a user is to take out the optical disk 4, he or she can peel off the peel-off part 140 to take out the optical disk 4. By this method, the optical disk 4 can be effectively protected and a cover of the optical disk 4 can be seen directly; whereas, entire beauty of the packaging will not be spoiled upon taking out the optical disk 4.

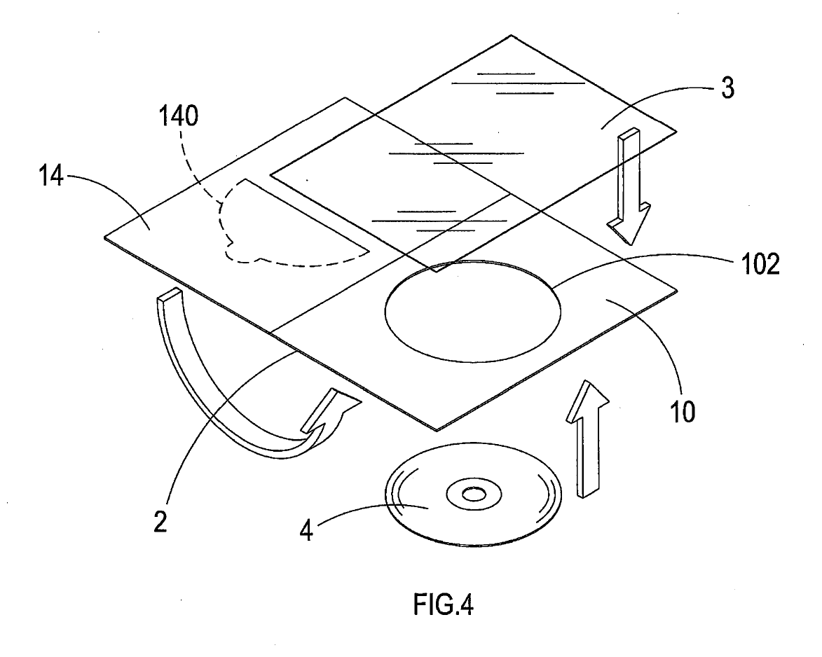

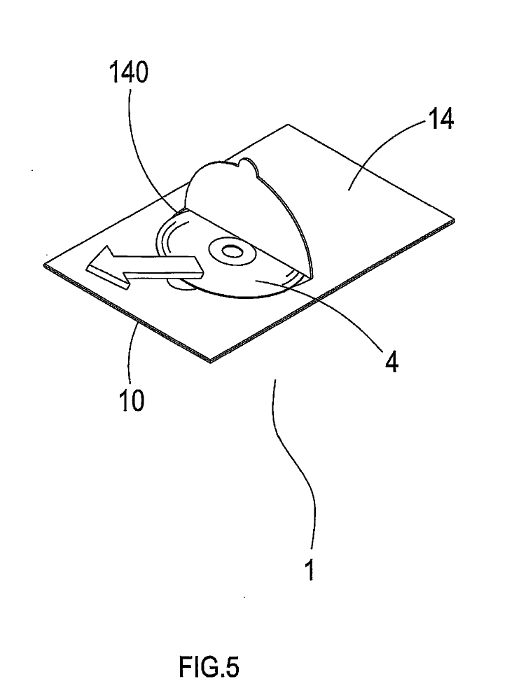

Referring to FIGS. 4 and 5, it shows a schematic view of a state that a cartridge of the present invention is adhered and a schematic view of a state of the present invention that an optical disk is taken out. As shown in the drawings, first, the first sheet 10 is defined with a position of the first window 102 and the surface of the first sheet 10 is adhered with the separator film 3 which is sufficient to cover the first sheet 10, with transparency of the separator film 3 being able to result in all kinds of visual effects. After the separator film 3 has been adhered, the first sheet 10 and the bottom sheet 14 are bended with respect to each other and adhered with the adhesive layer 2. Next, after the first sheet 10 and the bottom sheet 14 have been adhered, the optical disk 4 is put into the first window 102 of the first sheet 10. As a thickness of the first sheet 10 provides for loading the optical disk 4, the position of the optical disk 4 can be fixed. Therefore, the optical disk 4 can be completely emplaced inside to avoid from being scratched by an external effect and a cover of the optical disk 4 can be directly seen through the first window 102. By the aforementioned method, the making of an entire optical disk packaging is accomplished.

Moreover, the bottom sheet 14 is defined with the peel-off part 140 and when the user is to retrieve the optical disk 4 in the packaging, he or she can peel off along the peel-off part 140, allowing a notch to be formed at the bottom sheet 14. As the peel-off range of the peel-off part 140 is sufficient for removing out the optical disk 4, the packaging structure after taking out the optical disk 4 can maintain original beauty without damaging original integrity.

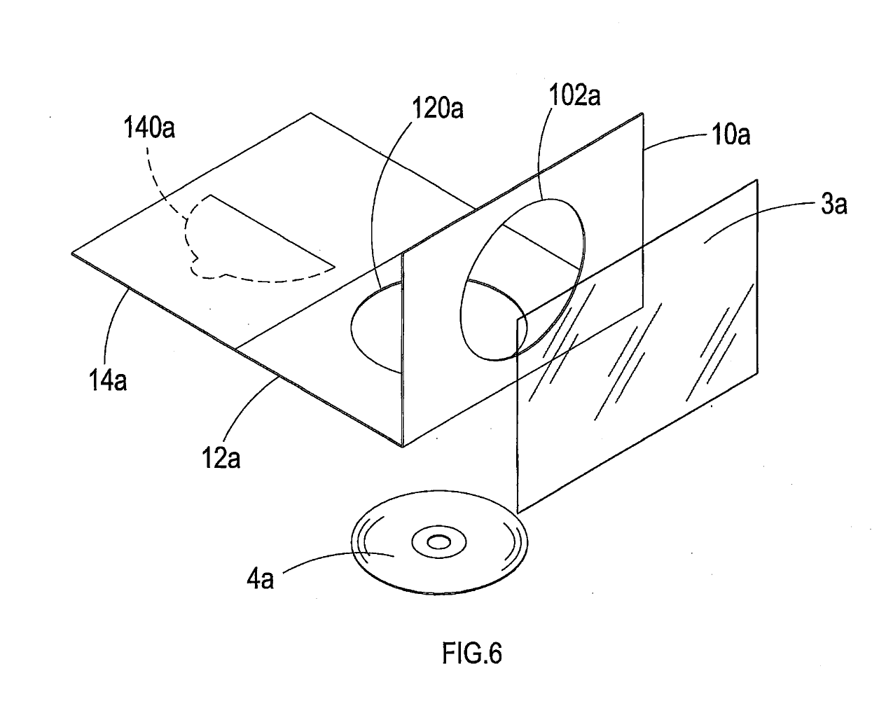

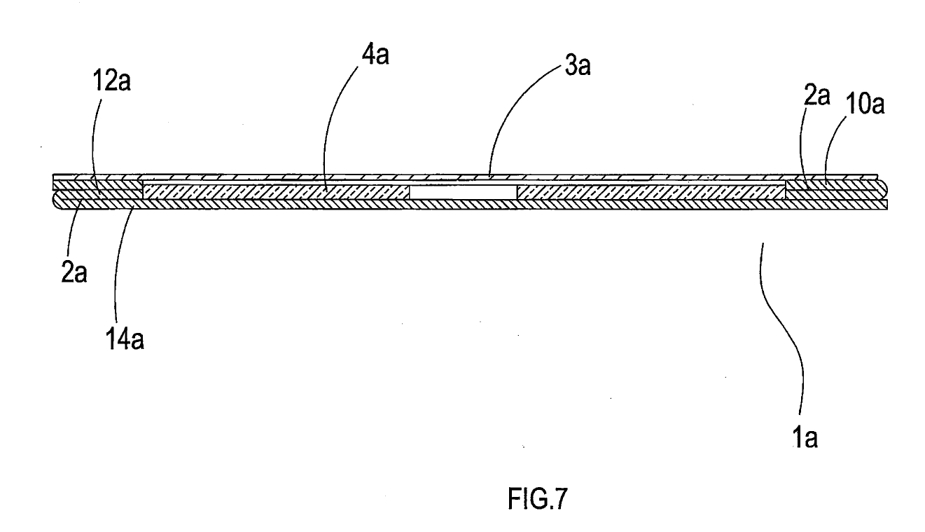

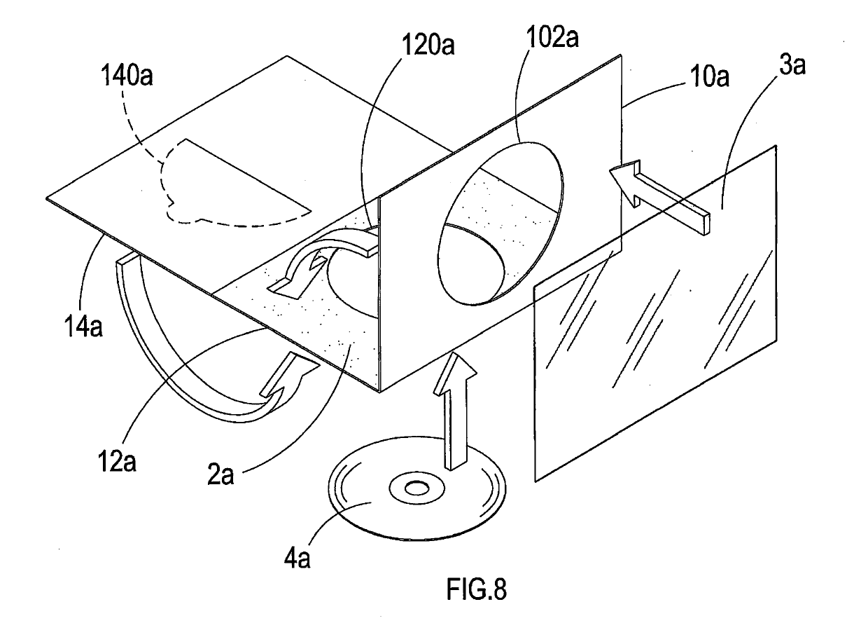

Referring to FIGS. 6 to 8, it shows a three-dimensional exploded view of another preferred embodiment of the present invention, a cutaway view of FIG. 6 and another schematic view of a state that a cartridge is adhered. As shown in the drawings, an optical disk packaging structure of the present invention comprises primarily a cartridge 1a and an optical disk 4a, wherein the cartridge 1a is formed by adhering correspondingly a first sheet 10a, a second sheet 12a and a bottom sheet 14a through an adhesive layer 2a; the first sheet 10a is formed with a first window 102a and a surface of the first sheet 10a is coated with a layer of separator film 3a (transparent or semi-transparent); and the second sheet 12a is formed with a second window 120a to emplace the optical disk 4a. Hence, through the second window 120a, a type of the optical disk 4a which is put on the second window 120a can be seen. In addition, the bottom sheet 14a is defined with a peel-off part 140a. As a peel-off range of the peel-off part 140a is sufficient for to removing out the optical disk 4a, when the user is to take out the optical disk 4a, he or she can peel off the peel-off part 140a to take out the optical disk 4a. By this method, the optical disk 4a can be effectively protected and entire beauty of the packaging will not be spoiled when taking out the optical disk 4a.

First, the first sheet 10a is defined with a position of the first window 102a and the surface of the first sheet 10a is adhered with the separator film 3a which is sufficient to cover the first sheet 10a, with transparency of the separator film 3a being able to result in all kinds of visual effects. After the separator film 3a has been adhered, the first sheet 10a and the second sheet 12a are bended with respect to each other and are adhered with the adhesive layer 2a. Next, after the first sheet 10a and the second sheet 12a have been adhered, the optical disk 4a is put into the second windows 120a of the second sheet 12a. After emplacing the optical disk 4a, the adhesive layer 2a is used again to adhere the bottom sheet 14a at the other side of the second sheet 12a. Accordingly, the optical disk 4a can be completely emplaced inside to avoid being scratched by an external effect and a cover of the optical disk 4a can be directly seen through the first windows 102a and the second windows 120a. By the aforementioned method, the making of an entire optical disk packaging is accomplished.

Furthermore, the bottom sheet 14a is defined with the peel-off part 140a and when the user is to retrieve the optical disk 4a in the packaging, he or she can peel off along the peel-off part 140a, allowing a notch to be formed at the bottom sheet 14a. As the peel-off range of the peel-off part 140a is sufficient for removing out the optical disk 4a, the entire packaging structure of the optical disk 4a will not be damaged and original beauty of the packaging structure can be maintained after taking out the optical disk 4a without damaging original integrity.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An optical disk packaging structure comprising a cartridge which is provided with a first sheet formed with a first window, with a side of the first sheet being coated with a separator film and a side edge of the first sheet being extended with a bottom sheet corresponding to the first sheet, whereas a pre-determined position of the bottom sheet being defined with a peel-off part.

2. The optical disk packaging structure according to claim 1, wherein a peel-off range of the peel-off part is sufficient for removing out an optical disk.

3. The optical disk packaging structure according to claim 1, wherein the first sheet and the bottom sheet are adhered by an adhesive layer.

4. The optical disk packaging structure according to claim 1, wherein the separator film is further provided with a transparent or semi-transparent configuration.

5. The optical disk packaging structure according to claim 1, wherein a thickness of the first sheet provides for loading an optical disk.

6. An optical disk packaging structure comprising a cartridge which is provided with a first sheet formed with a first window, a side of the first sheet being coated with a separator film, a side edge of the first sheet being extended with a second sheet corresponding to the first sheet, the second sheet being formed with a second window to accommodate an optical disk, the other side edge of the second sheet, back away from the first sheet, being extended with a bottom sheet corresponding to the second sheet and a pre-determined position of the bottom sheet being defined with a peel-off part.

7. The optical disk packaging structure according to claim 6, wherein a peel-off range of the peel-off part is sufficient for removing out an optical disk.

8. The optical disk packaging structure according to claim 6, wherein the first sheet and the second sheet are adhered by an adhesive layer.

9. The optical disk packaging structure according to claim 6, wherein the other side of the second sheet, back away from the first sheet, is adhered with the bottom sheet by an adhesive layer.

10. The optical disk packaging structure according to claim 6, wherein the separator film is further provided with a transparent or semi-transparent configuration.
